(19) United States
(12) Patent Application Publication
(10) Pub. No.: US 2013/0246298 A1
(43) Pub. Date: Sep. 19, 2013

(54) System and Method for Facilitating Optimized Shipping in a Transport Management System

(71) Applicants: Timothy J. Higham, St. Petersburg, FL (US); Mike Olson, St. Petersburg, FL (US); Philip Smoak, Palmetto, FL (US); Evan Portwood, Mulberry, FL (US); Justin Heath, Bartow, FL (US)

(72) Inventors: Timothy J. Higham, St. Petersburg, FL (US); Mike Olson, St. Petersburg, FL (US); Philip Smoak, Palmetto, FL (US); Evan Portwood, Mulberry, FL (US); Justin Heath, Bartow, FL (US)

(73) Assignee: INMOTION GLOBAL, INC., St. Petersburg, FL (US)

(21) Appl. No.: 13/424,126

(22) Filed: Mar. 19, 2012

(51) Int. Cl. G06Q 50/28

(52) U.S. Cl. 705/335

(57) ABSTRACT

Load data relating to a particular load requiring transport, stored internal lane rate data and stored external lane rate date are processed to determine a market lane rate. If the determined market lane rate exceeds an offered lane rate, a market lane rate trend graphic is presented on the display of the customer computing device, thereby informing the customer of the market lane rates relating to the particular load. If the determined market rate does not exceed the offered lane rate, the method further includes processing the stored load data along with stored rules data that includes at least one rule to determine if the store load data violates the at least one rule. If the least one rule is not violated, a Move Load icon is presented on the display of the customer computing device which provides a inconspicuous visual indication that capacity for the load is available.

### FIELD OF THE INVENTION

The present invention relates generally to shipping logistics, and more particularly, relating to an internet implemented system and method for facilitating optimized shipping in a transport management system that operates to simplify the complex task of carrier to load matching while reducing shipping costs and reducing carrier deadhead miles.

### BACKGROUND OF THE INVENTION

Shipping logistics involves the complex task of a shipper contracting with a carrier to transport goods from one location to another. Particularly, the complexity is commonly associated with a shipper locating a carrier that has available capacity to meet load requirements on a particular lane at an optimized lane rate, e.g. the lowest shipping rate possible given the constraints governed by the load requirements. Similarly, complexity is commonly associated with a carrier locating a load requiring transport to fill the carrier's load capacity while at the same time reducing the carrier's deadhead miles to have competitive shipping rates. That is, carriers are more inclined to lower their rates for shipments that go to locations where they are likely to engage a return or additional load.

Shipping logistics is particularly burdensome for the small shipper, small carrier and independent driver because they are unable to leverage the efficiencies afforded to large scale shippers and carriers. Frequently, shippers and carriers alike have to resort to using bulletin boards which are difficult and time consuming to read and compare to ensure most efficient transport of a load.

Accordingly, there is a need for an improved system and method for facilitating optimized carrier selection in a transport management system that at least partially overcomes deficiencies in the field of transport management.

### SUMMARY OF THE INVENTION

The embodiments of the present invention addresses this need by providing a system and method that provides simplified transport logistics from both the shipper and carrier aspects, thereby minimizing shipper transport costs and carrier deadhead miles.

Embodiments of the present invention also provide a transport logistics management module that is provided to shippers as software as a service, and in embodiments, is accessed using a computing device equipped with a conventional internet web browser.

Embodiments of the present invention also provide method and system including a readily recognizable computer icon that is displayed to a shipper to indicate to the shipper that capacity for a load is available, thereby eliminating the burdensome task of a shipper reading complex carrier and load tables to determine available capacity for the load.

Embodiments of the present invention also provide a method and system that determines a market lane rate value as a function of internally collected lane rates and externally collected lane rates, and in embodiments, a market lane rate trend graphic is generated and displayed to the shipper, thereby allowing the shipper to more efficiently determine an offered lane rate for the given load.

To achieve these and other advantages, in general, in one aspect, a method for optimized shipping implemented by a system comprising a customer computing device and a transport management entity computing device is provided. The method includes processing stored load data relating to a particular load requiring transport, stored internal lane rate data and stored external lane rate date to determine a market lane rate. If the determined market lane rate exceeds an offered lane rate, a market lane rate trend graphic is presented on the display of the customer computing device, thereby informing the customer of the market lane rates relating to the particular load. If the determined market rate does not exceed the offered lane rate, the method further includes processing the stored load data along with stored rules data that includes at least one rule to determine if the store load data violates the at least one rule. If the least one rule is not violated, a Move Load icon is presented on the display of the customer computing device which provides a inconspicuous visual indication that capacity for the load is available.

In general, in another aspect, a method for optimized shipping implemented by a system comprising a customer computer device and a transport management entity computer device, the customer computer device and the transport management entity computer device connected by a data communication network is provided. The method includes displaying graphical user interface on a display of the customer computer device to allow a customer to enter load data corresponding to a commodity to be moved. The load data includes at least an offered lane rate, a commodity type, an insurance value, origin information and destination information. The load data, internal lane rate data and external lane rate data are processed by the transport management entity computer device to determine a market lane rate in response to receiving the load data from the customer computer device. If the determined market lane rate exceeds an offered lane rate, a market lane rate trend graphic is presented on the display of the customer computer device, thereby informing the customer of the market lane rates relating to the particular load. If the determined market rate does not exceed the offered lane rate, the method further includes processing the stored load data along with stored rules data that includes at least a commodity type rule, an insurance value rule, a lane rule and a time rule to determine if the load data violates any one of the rules. If no rule is violated, a Move Load icon is presented on the display of the customer computer device which provides an inconspicuous visual indication that capacity for the load is available.

The method may further include displaying load data in a Common Ground table by the transport management entity computer device for manual dispatch of the load if the market lane rate exceeds the offered lane rate or if the load data violates a rule.

In general, in another aspect, a non-transitory computer-readable medium that provides processor executable instructions for causing a computer to perform a method of transportation of a commodity is provided. The method including receiving at a transport management entity computer device load data corresponding to a commodity requiring transport from a customer computer device connected to the transport management entity computer device by a communication network. The load data along with stored internal lane rate data and stored external lane rate date is processed by the transport management entity computer device to determine a market lane rate. If the determined market lane rate exceeds an offered lane rate, a market lane rate trend graphic is presented on the display of the customer computer device, thereby informing the customer of the market lane rates relating to the particular load. If the determined market rate does not exceed the offered lane rate, the method further includes processing the stored load data along with stored rules data that includes at least one rule to determine if the store load data violates the at least one rule. If the determined market rate does not exceed the offered lane rate, the method further includes processing the stored load data along with stored rules data that includes at least one rule to determine if the store load data violates the at least one rule. If the least one rule is not violated, a Move Load icon is presented on the display of the customer computing device which provides an inconspicuous visual indication that capacity for the load is available.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a block diagram of a system for optimized carrier selection in a transport management System in accordance with the principles of at least one embodiment of the present invention;

FIG. 2 is a block diagram of a user computer device in accordance with a non-limiting example;

FIG. 3 is a block diagram of transport management computer system in accordance with a non-limiting example;

FIGS. 4, 5, and 6 illustrate a flowchart depicting a process according to an embodiment of the present invention, wherein FIG. 4 illustrated a lane rate engine and FIG. 5 illustrates a rules engine;

FIG. 7 illustrates an example of a market lane rate trend graphic that may be displayed to a user in the implementation of the system and during at least one embodiment of the present invention;

FIG. 8 illustrates an example screen shot of a load build that is displayed to a user without showing a “Move Load” icon; and

FIG. 9 illustrates an example screen shot of the load build of FIG. 8 displaying the “Move Load” icon to a user.

### DETAILED DESCRIPTION OF THE INVENTION

The following detailed description of embodiments of the invention is made in reference to a system and method for facilitating optimized shipping in a transport management system, wherein the transportation service provided is over-the-road trucking (OTR). However, one skilled in the field of the invention will readily recognize the systems and methods described and implemented herein may also be applied to other modes of transportation such as rail, air, ship or intermodal.

The following includes definitions of selected terms employed herein. The definitions include various examples and/or forms of components that reside within the scope of a term and that may be used for implementation. The definitions provided herein are not intended to be limiting.

User or Shipper, for the purpose of this description, refers one or more persons, or business entities having a need to transport one or more loads from an origin location to a destination location. Load, for the purpose of this description, refers to a shipment of commodities requiring transport or in transport, and may refer to a single stop load, a multi-stop load, a full truck load, a less than full truck load and the like. Lane, for the purpose of the description, refers a route of transport for a load including the origin location and the destination location.

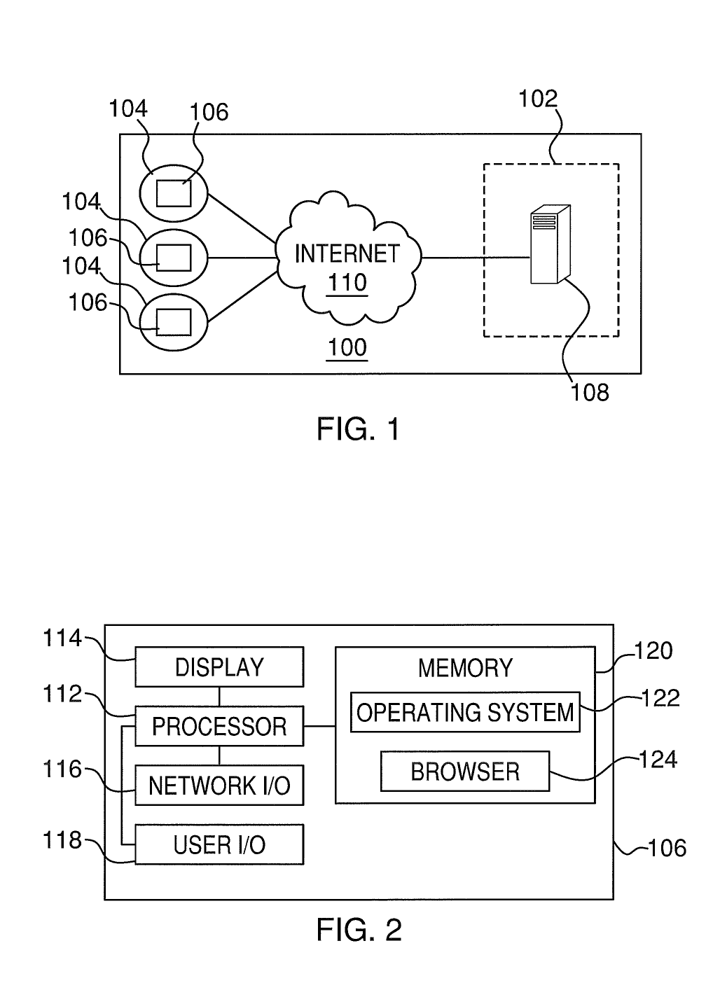

Diagrammatically represented in FIG. 1 is a computer implemented system 100 for optimized carrier selection in a transport management system in accordance with at least one embodiment of the present invention for providing over-the-road trucking of freight. As illustrated in FIG. 1, system 100 includes one or more shippers 104 and a transport management entity 102. Shipper 104 includes a computer device 106 and transport management entity 102 includes a computer system 108. The shipper computer device 106 and the transport management entity computer system 108 are interconnected through a network 110, which is illustratively embodied herein as the Internet (World Wide Web). Of course, one skilled in the art will readily recognize network 110 may be in the form of another data communication network other than the Internet. For example, network 110 may comprise an intranet, a local area network (LAN), wide area network (WAN), virtual private network (VPN), wireless communication network or any other suitable data communication network.

Shipper computer device 106 may be a desktop computer, a portable computer, a laptop, a notebook computer, a personal digital assistant (PDA), a smart phone, a tablet computer, personal computer device or the like. In one aspect, shipper computer device 106 minimally requires a connection to the Internet, a graphical display, a user input/output and the ability to operate an internet web browser for display on the graphical display and interaction through the user input/output.

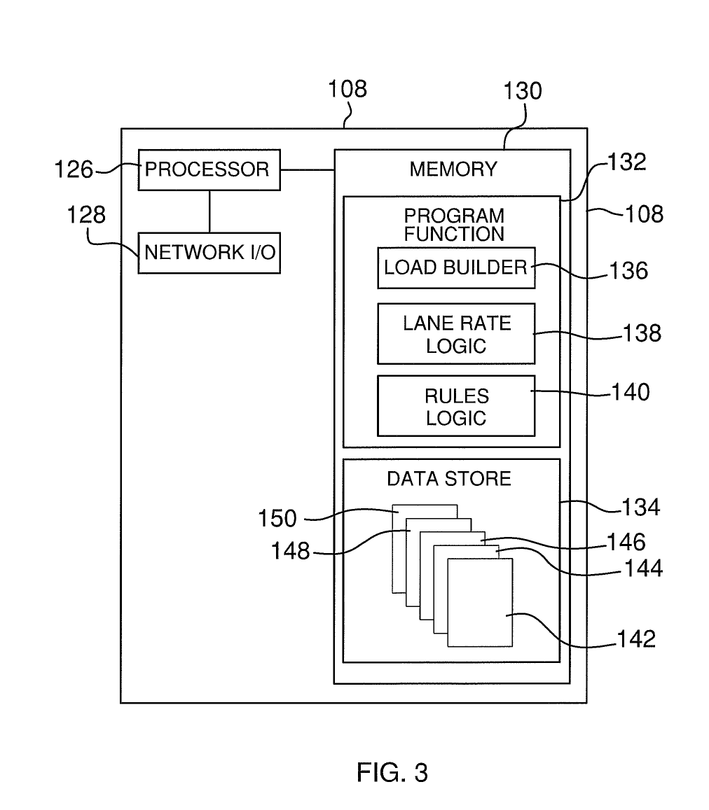

With reference to FIG. 2, in an example, shipper computer device 106 comprises a processor 112, a graphical display 114, a network input/output 116 for accessing network 110, a user input/output 118, memory 120, an operating system 122, and an Internet browser application 124. Processor 112 may be a CPU, and operates to execute software or programs stored in the memory 120 to perform certain operations and/or functions. Memory 120 may include various forms of computer-readable medium including, but not limited to non-volatile media and volatile media. Non-volatile media may include, for example, optical or magnetic discs. Volatile media may include, for example, semiconductor memory, dynamic memory, Synchronous dynamic random access memory (SDRAM), dynamic random access memory (DRAM) and the like.

Processor 112 is configured to execute the Internet browser application 124 stored in memory 120, as will be further detailed below, to interface with the transport management entity computer system 108 in performing a commercial transaction with the transport management entity 102 in securing a carrier for a load requiring transport.

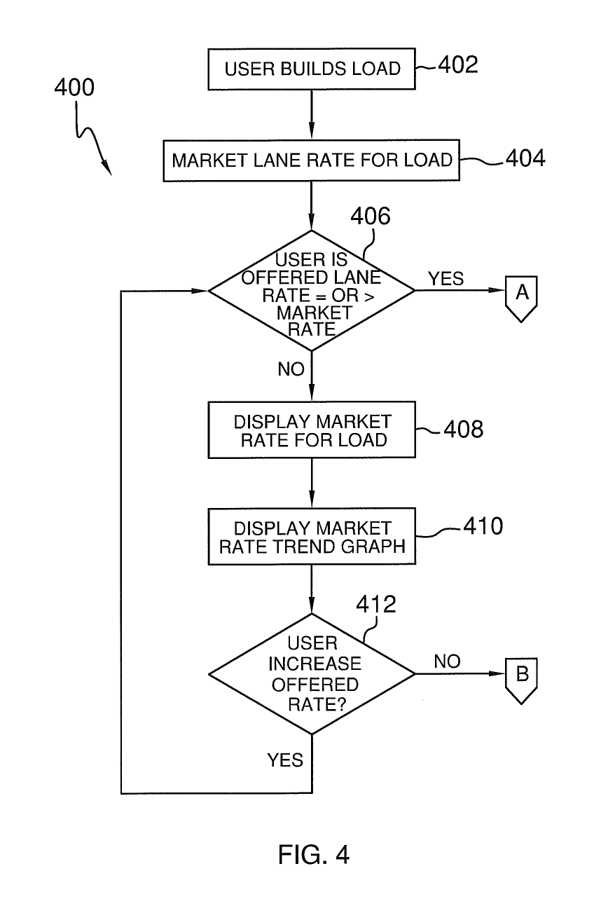

Transport management entity computer system 108 includes one or more computer servers, such as, but not limited to web servers, application servers, database servers, and the like. With reference to FIG. 3, the transport management entity computer system 108 is schematically illustrated in basic form for the purpose of illustrative clarity and in sufficient detail that one of skill in the art will readily appreciate and understand the implementation of the systems and methods described herein without further illustrative detail. The transport management entity computer system 108 at least includes a processor 126, a network input/output 128 for accessing network 110, memory 130 including one or more programs or executable software logic 132 and data store 134. The software logic 132 may include a load builder function 136, a lane rate logic function 138 and a rules logic function 140. Of course, software logic may include additional functions not illustrated here. Data store may include one or more databases, such as but not limited to a shipper database 142, an internal lane rate database 144, an external lane rate database 146, and an equipment data base 148, and a rules database 150. It is to be understood, that additional databases or one or more of the databases 142, 144, 146, 148 and 150 may be consolidated into a lesser number of databases or expanded in to a greater number of databases accordingly as desired for relational efficiency in performing the process operations that are described herein.

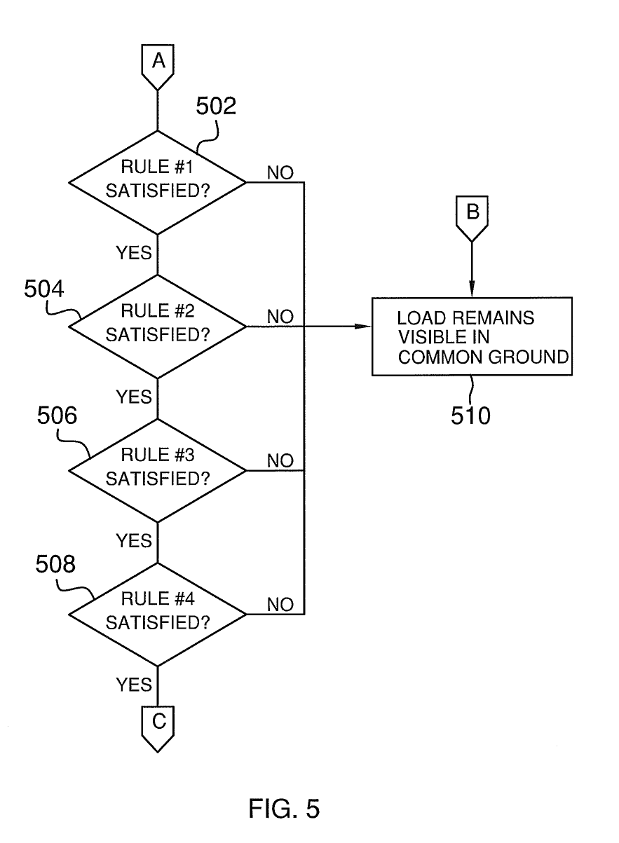

With reference to FIGS. 4 through 6, there is illustrated a process flow chart 400 embodying principals of the shipper or user's 104 interaction with the transport management entity 102 of system 100 and the process flow of system 100. The process of arranging to transport a load in accordance with system 100 will be described in relation to process flow chart 400. It is important to note, the process may be arranged in another order as required to accommodate more efficient information processing. The following discussion is taken in the context of a user or shipper 104 that has already been registered with the system 100. The process of registering a user 104 with system 100 forms no part of the embodiments of this invention, and therefore a complete description thereof is not required for an understanding of the system 100.

Initially, at step 402, a user or shipper 104 using the browser application 124 on computer device 106 accesses a graphical user interface of the load builder function 136 of system 100. Using the load builder function 136, shipper 104 enters information regarding a load that the shipper requires to be moved into system 100. Load data entered into the load builder function 136 includes information regarding the description of goods or freight to be transferred (commodity type), such as origin location, destination location, pieces, weight, commodity description, pickup date, pickup time, delivery data, delivery time, trailer type, offered lane rate per mile or flat lane rate, accessorials, required insurance, value of the freight and/or other information as necessary. Other relevant information pertaining to the shipper 104, such as identification number, location, payment arrangements, contract terms, etc. may be loaded automatically into load builder function 136 as needed by computer system 108 from stored data, for example data from the shipper data base 142.

Once the load has been built or entered, the process continues to step 404. At step 404, lane rate engine 138 operates to generate a market lane rate for the load, and operates to generate market lane rate trends. The market lane rate for the load is generated as a function of internal lane rate data and external lane rate data. Internal lane rate data is stored in internal lane rate data base 144 and includes load information of loads moved by the transport management entity 102. External lane rate data is stored in the external lane rate data base 146 and includes load information of loads moved by 3rd transport providers. The lane rate engine 138 compares the internal lane rate data and the external lane rate date to the load information pertaining to the load to be moved to identify commonalities between the internal lane rate data and the external lane rate date and the load information. The internal lane data and the external lane data are weighted based upon a function of the commonalties with the shipper entered load date. Lane rates having higher commonalties and lower data value variances are weighted higher than lane rates with fewer commonalties and higher data value variances. A market lane rate is then calculated as a function of the weighted lane rates. Additionally, market lane rate trends are calculated as a function of the weighted lane rates.

At step 406, an inquiry is made to determine if the user's offered lane rate is equal to or greater than the market lane rate determined at step 404. If the offered lane rate is not equal to or great than the market lane rate, the process proceeds to step 408. At step 408, the market lane rate trend is displayed to the user. The market lane trend rate may be 3-day trend, a 90-day trend or a market lane trend rate taken over another time range as desired either by the transport management entity 102 or the user 104. For example, the user may be provided with an option to increase or decrease the time range within a time range constrain set by the transport management entity.

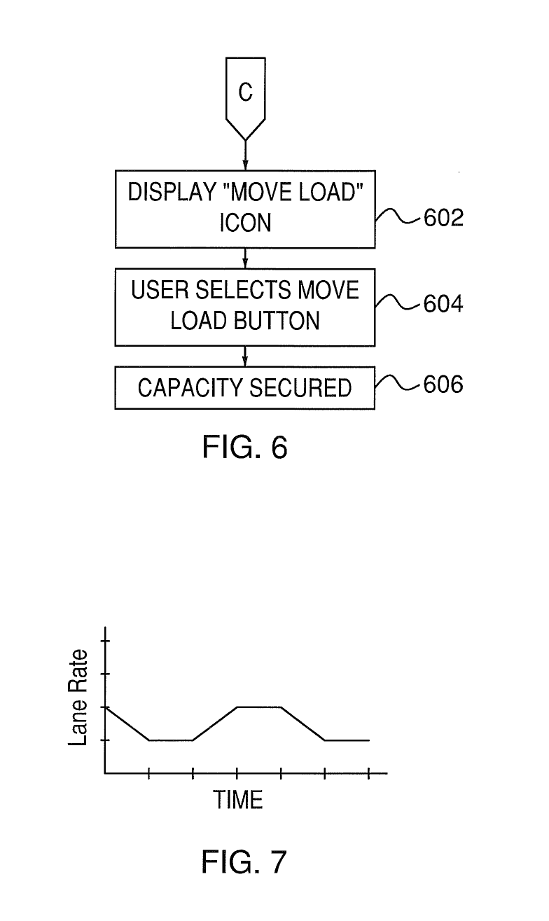

At step 410, a market lane rate trend graph, such as a line graph or bar graph is displayed to the user, an example of which is illustrated in FIG. 7. The market lane rate trend graph provides a pictorial view of the lane rate over a period of time, and may additionally include lane rates for multiple types of equipment, e.g. refrigerated truck, non-refrigerated truck, flat bed, etc. It is import to note, that steps 408 and 410 may be reversed, operate simultaneously, or one may even be omitted so long as the other remains.

At step 412, the user, having been provided market lane rates for the load, is given the opportunity to increase the offered lane rate. If user increases the offered rate, the process returns to step 406 to once again determine if the new offered rate lane is equal to or greater than the market lane rate. If the user does not increase the offered rate the process proceeds to step 510, which will be explained below.

Now returning to step 406, if the user's offered rate is greater than or equal to the market lane rate calculated at step 404, the process proceeds to step 502, illustrated in FIG. 5. Beginning at step 502, the rules engine 140 operates to test the shipper load data against global rules within the system 100 according to business constraints or rules established by the transport management entity. Global rules may include time to secure capacity for the load, capacity availability on the lane, commodity type, insurance value, etc. Of course additional rules or alternative rules may be implements as required or desired by the transport management entity 102.

Therefore, at step 502, a query is performed on the shipper load data to determine if one or more values of the shipper load data violate a first rule of system 100. For example, at step 502, a query is performed on the shipper load data to determine if there is a sufficient amount of time available to secure capacity for the load. The amount of time required to be available to secure capacity is a function of the load criteria, and is adjusted accordingly. For example, more time may be required to secure a capacity in one region of the country as opposed to another region of the country. If at step 502, it is determined a sufficient amount of time is available to secure capacity the process continues to step 504, else the process continues to step 510.

At step 504, the rules engine 140 once again operates to test load data against a system global constraint. For example, at step 504, a query is performed against the load data to determine if the lane has been designated to be serviceable by the transport management entity 102. In an example, a lane may be designated to be serviceable if there is a need to move a load out of or within a predetermined distance from the place of origin of the load to be moved. A lane may also be designated to be serviceable if there is a need to pick up a load at or within a predetermined distance from the place of destination of the load to be moved. Additionally, a lane may also be designated to be serviceable if the lane is routinely used or if entity 102 knows it is able to service the load based upon predetermined constraints or manual entering. This process is directed towards lane optimization to reduce carrier deadhead miles, and ultimately shipping costs passed on to the user. If at step 504, it is determined the lane is serviceable, the process proceeds to step 506, else the process proceeds to step 510.

At step 506, a query is performed against the load data to determine if the commodity type of the load to be moved violates a global constraint. For example, the transport management entity 102 may set a global constraint against moving a load comprising a commodity that is designated has HAZMAT. Additionally, at step 506, a query may be performed against the load data to determine if the required equipment is available to transport the load. If as step 506, it is determined the commodity is transportable and the required equipment is available, the process proceeds to step 508, else the process proceeds to step 510.

At step 508, a query is performed against the load data to determine if the value of the load to be moved violates a global constraint. For example, the transport management entity 102 may set a global constraint against moving a load having a value greater than a predetermined maximum load value amount and/or greater than a predetermined insurance requirement. If as step 508, it is determined the value of the load and insurance requirements do not violate the global constraint, the process proceeds to step 602, else the process proceeds to step 510.

At step 510, the user's load becomes or remains visible in the transport management entity's 102 Common Ground table for dispatch and manual override. For example, if a load violates any of the above described process steps and becomes or remains visible in the Common Ground table, a dispatcher of entity 102 may communicate with a carrier to determine if the carrier is able to move the load given the specific load requirement, e.g. a special trailer type, high-value insurance, etc.

Before proceeding to step 602, it is important to note that steps 502, 504, 506 and 508 may be performed in an alternative order, and further, additional steps or alternate steps may be included in the rules engine that are not specifically illustrated or discussed herein.

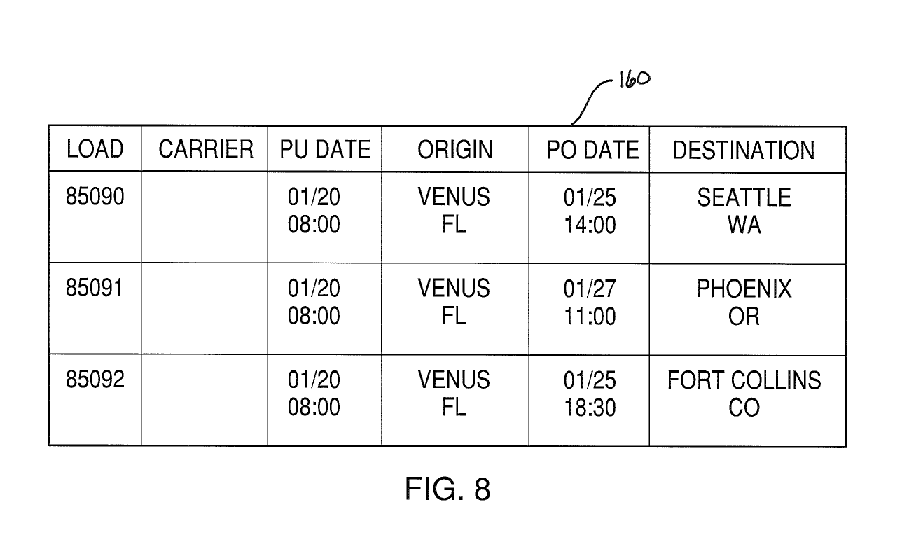

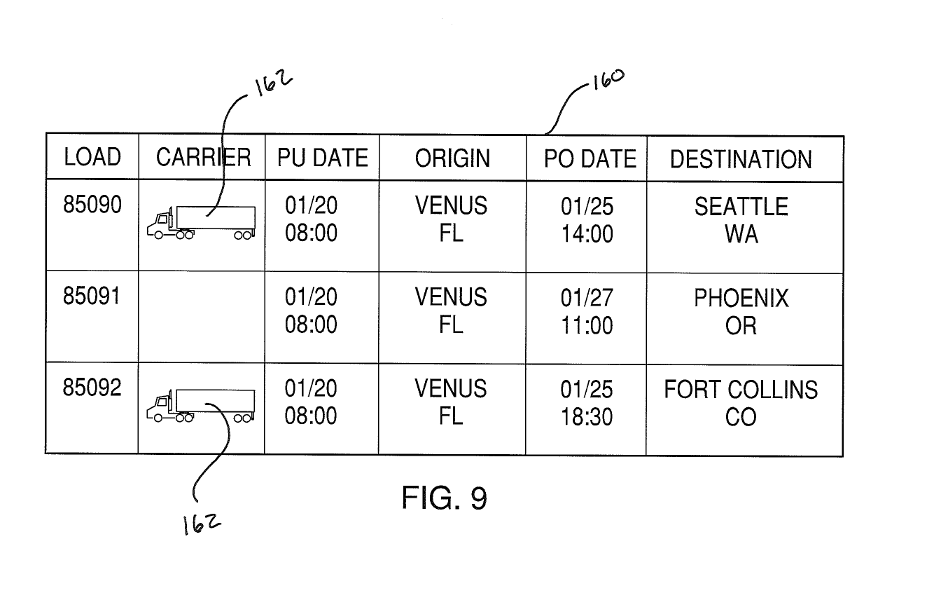

At step 602, a “Move Load” icon is displayed to the user on the graphical user interface rendered by the browser application operating on the shipper's computer device. The display of the “Move Load” icon indicates to the user that the transport management entity 102 believes it is able to secure the capacity for the load at the offered lane rate. In FIG. 8, there is illustrated a screen shot of a representative graphical user interface 160 prior to the “Move Load” icon being displayed to the user. In FIG. 9, there is illustrated the screen shot of the representative graphical user interface 160 of FIG. 8 now showing the “Move Load” icon 162 displayed to the user. Proceeding to step 604, the user, desiring to move the load, selects a move load button. Finally, at step 606, capacity for the load is secured, and the load will be moved in accordance with the load criteria entered by the user at step 402.

The above description describes a system and method which, among other aspects, greatly simplifies the burdensome task of locating shipping capacity by a user or shipper having a load requiring transport. Upon the system loading or displaying the “Move Load” icon 162, the shipper is assured the load may be moved per the load criteria along an optimized lane, which thereby ensures cost efficient shipment of the load and shipping costs savings by the shipper.

Although the above description is made in relation to a cloud based application interfaced using a standard internet web browser, other embodiments are possible, albeit potentially less desirable. For example, software applications may be developed for execution locally on the shipper computer 106.

A number of embodiments of the present invention have been described. Nevertheless, it will be understood that various modifications may be made without departing from the spirit and scope of the invention. Accordingly, other embodiments are within the scope of the following claims.

What is claimed is:

1. A method for optimized shipping implemented by a system comprising a customer computer device and a transport management entity computer device, the method comprising the steps of:
a) processing stored load data, stored internal lane rate data and stored external lane rate date to determine a market lane rate;
b) displaying on a display of the customer computer device a market lane rate trend graphic if said determined market lane rate exceeds an offered lane rate;
c) processing said stored load data and stored rules data comprising at least one rule to determine if said store load data violates said at least one rule if said determined market lane rate does not exceed said offered lane rate; and
d) displaying on said display of the customer computer device a move load icon indicating capacity for a load related to said stored load data is available if during said processing step c it is determined said stored load data does not violate said at least one rule.

2. The method of claim 1, wherein said stored load data at least includes said offered lane rate, commodity type, origin information and destination information.

3. The method of claim 1, wherein said processing step a is executed by said transport management entity computer device.

4. The method of claim 1, wherein said market lane rate trend graphic corresponds to the processed stored load data, stored internal lane rate data and stored external lane rate data.

5. The method of claim 4, wherein said market lane rate trend graphic represents a market lane rate over a time range.

6. The method of claim 1, wherein said stored load data includes a commodity type, and wherein said at least one rule includes acceptable commodity types.

7. The method of claim 1, wherein said stored load data includes an insurance value, and wherein said at least one rule includes an insurance value limit.

8. A method for optimized shipping implemented by a system comprising a customer computer device and a transport management entity computer device, the customer computer device and the transport management entity computer device connected by a data communication network, the method comprising the steps of:
a) displaying graphical user interface on a display of the customer computer device to allow a customer to enter load data corresponding to a commodity to be moved, said load data including at least an offered lane rate, commodity type, insurance value, origin information and destination information;
b) receiving and storing at the transport management entity computer device said load data;
c) processing said load data, internal lane rate data and external lane rate data by the transport management entity computer device to determine a market lane rate in response to receiving and storing said load data;
d) displaying on the display of the customer computer device a market lane rate trend graphic if said determined market lane rate exceeds said offered lane rate;
e) processing said load data and stored rules data comprising at least a commodity type rule, an insurance value rule, a lane rule and a time rule to determine if said load data violates any one of said rules if said determined market lane rate does not exceed said offered lane rate; and
f) displaying on said display of the customer computer device a move load icon in said graphical user interface indicating capacity for a load related to said load data is available if during said processing step e it is determined said load data does not violate any one of said rules.

9. The method of claim 8, further comprising the step of:
g) displaying load data in a common ground table by said transport management entity computer device for manual dispatch of the load if during said processing step e it is determined said load data does violate any one of said rules.

10. The method of claim 8, wherein said market lane rate trend graphic corresponds to the processed stored load data, stored internal lane rate data and stored external lane rate data.

11. The method of claim 11, wherein said market lane rate trend graphic represents a market lane rate over a time range.

12. A non-transitory computer-readable medium that provides processor executable instructions for causing a computer to perform a method of transportation of a commodity, the method comprising:
a) receiving at a transport management entity computer device load data corresponding to a commodity requiring transport from a customer computer device connected to said transport management entity computer device by a communication network;
b) processing load data, stored internal lane rate data and stored external lane rate date to determine a market lane rate by said transport management entity computer device;
c) displaying on a display of the customer computer device a market lane rate trend graphic if said determined market lane rate exceeds an offered lane rate;
d) processing said load data and stored rules data comprising at least one rule to determine if said load data violates said at least one rule if said determined market lane rate does not exceed said offered lane rate by said transport management entity computer device; and
e) displaying on said display of the customer computer device a move load icon indicating capacity for a load related to said stored load data is available if during said processing step d it is determined said stored load data does not violate said at least one rule.

13. The non-transitory computer-readable medium of claim 12, wherein said load data includes at least an offered lane rate, commodity type, insurance value, origin information and destination information; and wherein said stored rules data includes at least a commodity type rule, an insurance value rule, a lane rule and a time rule.

14. The non-transitory computer-readable medium of claim 12, wherein said market lane rate trend graphic corresponds to the processed load data, stored internal lane rate data and stored external lane rate data.

15. The non-transitory computer-readable medium of claim 14, wherein said market lane rate trend graphic represents a market lane rate over a time range.

16. The non-transitory computer-readable medium of claim 12, further comprising the step of:
f) displaying load data in a common ground table by said transport management entity computer device for manual dispatch of the load if during said processing step d it is determined said load data does violate said at least one rule.

17. The non-transitory computer-readable medium of claim 16, wherein said load data includes at least an offered lane rate, commodity type, insurance value, origin information and destination information; and wherein said stored rules data includes at least a commodity type rule, an insurance value rule, a lane rule and a time rule.

18. The non-transitory computer-readable medium of claim 17, wherein said market lane rate trend graphic corresponds to the processed load data, stored internal lane rate data and stored external lane rate data.

19. The non-transitory computer-readable medium of claim 18, wherein said market lane rate trend graphic represents a market lane rate over a time range.
